(19) United States
(12) Patent Application Publication
(10) Pub. No.: US 2014/0067408 A1
(43) Pub. Date: Mar. 6, 2014

(54) SYSTEMS AND METHODS FOR USE IN TRAINING MEDICAL TREATMENTS TO HEALTHCARE PROFESSIONALS

(71) Applicant: Douglas Brian Aach, Belleville, IL (US)

(72) Inventor: Douglas Brian Aach, Belleville, IL (US)

(21) Appl. No.: 13/602,356

(22) Filed: Sep. 4, 2012

(51) Int. Cl. G06Q 50/22

(52) U.S. Cl. 705/2

(57) ABSTRACT

A medical event information system includes at least one client computer, a memory area configured to store at least one property of an object, and a server system communicatively coupled to the client computer and the memory area. The memory area is configured to store data associated with a plurality of medical events, wherein each medical event resulted in a legal assertion being made by a patient following a surgical procedure. The server system is communicatively coupled to the at least one client computer and to the memory area. The server receives data including at least information relating to each patient associated with each medical event, information associated with errors relating to the medical event, and information relating to the outcomes of each medical event. The server identifies at least one action, that if corrected would have changed the outcome of each of the medical events identified.

### BACKGROUND OF THE INVENTION

The embodiments described herein relate generally to teaching and reference tools and, more particularly, to systems and methods for use in training medical treatments to healthcare professionals.

Despite technological advances, increased training, and revised standard procedures, the number of lawsuits against professionals has steadily increased. For example, despite advanced and prolonged training, and technologically-advanced instruments, the number of medical malpractice actions in the United States have increased in frequency during the past several years. Damage awards and costs associated with such lawsuits profoundly and adversely impact the practice of healthcare and medical procedures. According to the Joint Commission for Hospital Accreditation and the American Medical Association (AMA), the failure to diagnose, and errors in the understanding and use of medical devices and in surgical procedures, are some of the leading causes of patient injury and medical malpractice actions.

Although high-risk medical fields, procedures, and practitioners, can be identified, there are few training programs available that effectively and consistently reduce the risks of patient dissatisfaction and/or the risk of malpractice lawsuits. For example, according to the American College of Surgeons (ACS) of the approximately 26,000 surgeons active in the United States, the surgeons that have less than two-three years of experience, or the surgical residents in training, are considered to have the highest risks of malpractice. Learning to perform surgical procedures, and learning to use various medical devices, is often initially taught through textbooks, manuals, lectures, and videotapes, prior to performing supervised, actual “hands-on” training and/or “over-the-shoulder” training at training hospitals. Generally, training programs are based on the premise that it is better to teach surgical students the right way of doing a procedure the first time, rather than to unlearn their bad habits later. Often the surgical procedures, and associated surgical teaching methods, are based on long-established techniques and principles that may be encouraged, mandated, and/or impelled by medical organizations, such as medical organizations, such as the AMA or the ACS. Moreover, often changes to the surgical techniques and procedures are suggested by agencies, such as malpractice insurers, that offer a discount to surgical customers if surgical risk reduction activities, i.e., changes to procedures, are implemented.

For example, at least some malpractice insurers require their health care and surgical facilities to utilize electronic medical records (EMR) to gather information that may be used to verify risk reduction activities. More specifically, in some instances, compliance data and metrics are useful in reducing the risk of malpractice claims and injury. Electronic databases enable the physicians and healthcare facilities to document health care activity with increased precision and reliability. Generally, such data accumulation, including the documentation of medication reconciliation and critical test result notification, is often archived and can be used to reduce the malpractice liability risk to the physicians and healthcare facilities. Although such information may also be voluminous, it is often necessary to compile large amounts of other medical information for use in preparing to prosecute or defend a lawsuit or potential lawsuit relating to a medical procedure. Although such information may include data that may be useful in other medical contexts, such as training, access to the additional information is limited, and generally the additional information is destroyed immediately after the lawsuit has been resolved. Moreover, most known training resources and tools focus on the technical issues surrounding a medical treatment or a medical procedure or their associated technologies, and tend to ignore the risk and malpractice issues or other legal issues that may be associated with such procedures in the past.

### BRIEF DESCRIPTION OF THE INVENTION

In one aspect, a method of training a healthcare provider to perform a surgical procedure is provided. The method includes accessing, from a plurality stored medical events that each resulted in a legal assertion being made by a patient following a surgical procedure, data including at least information relating to each patient associated with each medical event, information associated with errors relating to the medical event, and information relating to the outcome of the surgical procedure associated with each medical event. The method also includes identifying, from the plurality of stored medical events, information relating to the surgical procedure to be performed, and identifying, if corrected, at least one action that would have changed the outcome of each of the medical events identified. The method further includes presenting the identified information to the healthcare provider to facilitate reducing the likelihood of errors being committed by the healthcare provider to perform the surgical procedure and to facilitate improving a quality of care provided by the healthcare provider.

In another aspect, a medical event information system is provided. The medical event information system includes at least one client computer, a memory area, and a server system. The memory area is configured to store data associated with a plurality of medical events, wherein each medical event resulted in a legal assertion being made by a patient following a surgical procedure. The server system is communicatively coupled to the at least one client computer and to the memory area. The server system is configured to receive from the at least one client computer, data associated with each of the plurality of medical events, wherein the data includes at least information relating to each patient associated with each medical event, information associated with errors relating to the medical event, and information relating to the outcome of the surgical procedure associated with each medical event and the legal proceeding associated with each medical event. The server is also configured to identify at least one action associated with each medical event that if corrected would have changed the outcome of each of the medical events identified, and to transmit to the at least one client computer for display to a user, a comparison between at least one error and at least one identified corrective action associated with each medical event to facilitate reducing errors performed by a healthcare provider performing a similar surgical procedure in the future.

In a further aspect, a method of training a healthcare provider to perform a medical treatment is provided. The training method comprises accessing, from a plurality stored medical events, data including at least information relating to each patient associated with each medical event, information associated with errors relating to the medical event, and information relating to the outcome of at least one of the medical treatment associated with each medical event. The method also comprises identifying, from the plurality of stored medical events, information relating to the medical treatment to be performed by the healthcare provider, and identifying, if corrected, at least one action that would have changed the outcome of each of the medical events identified. In addition, the method comprises presenting the identified information to the healthcare provider to facilitate reducing the likelihood of errors being committed by the healthcare provider when performing the medical treatment and to facilitate improving a quality of care provided by the healthcare provider.

### BRIEF DESCRIPTION OF THE DRAWINGS

FIG. 1 is a simplified block diagram of an exemplary medical event training system;

FIG. 2 is an expanded block diagram of an exemplary system architecture that may be used with the medical event training system shown in FIG. 1;

FIG. 3 is a flowchart that illustrates an exemplary training method that may be used with the medical event training system shown in FIG. 1; and

FIG. 4A-C is an exemplary summary report that may be produced using the medical event training system shown in FIG. 1.

### DETAILED DESCRIPTION OF THE INVENTION

Exemplary embodiments of systems, methods, and apparatus for use in for generating and using an intelligent medical event system in various stages of training physicians, surgeons, surgical residents, surgeons in training, and/or other medical or healthcare professionals, for example, are described herein. The embodiments described herein facilitate capturing information associated with a medical event in a database that is sortable for use in training healthcare providers in a manner that emphasizes learning based on an analysis of the risks, malpractice issues, or other legal issues that have been associated with such medical events in the past. The database described herein also stores the reasoning of skilled and/or expert personnel associated with the medical events and an analysis of deviations, if any, from established medical guidelines, rules, and procedures, and/or from an established, standard healthcare treatment. More specifically, the embodiments described herein facilitate generating and using a database to store a combination of medical events and any rule-based decisions, skill-based decisions, and/or knowledge-based decisions associated with such medical events, whether such decisions were properly-based in the past or not. Capturing the underlying reasoning associated with such events facilitates modifying and/or honing the behavior and decision-making process of medical personnel in making decisions that are more reliable, accurate, and/or faster regarding similar medical events occurring in the future. Enhancing or optimizing the reliability and relevancy of such decisions creates consistency in decisions and/or solutions to medical events and should facilitate enhancing the care provided to patients, enhancing the skills of healthcare providers, and reducing the risk of error and the likelihood of future patient injuries and/or dissatisfaction.

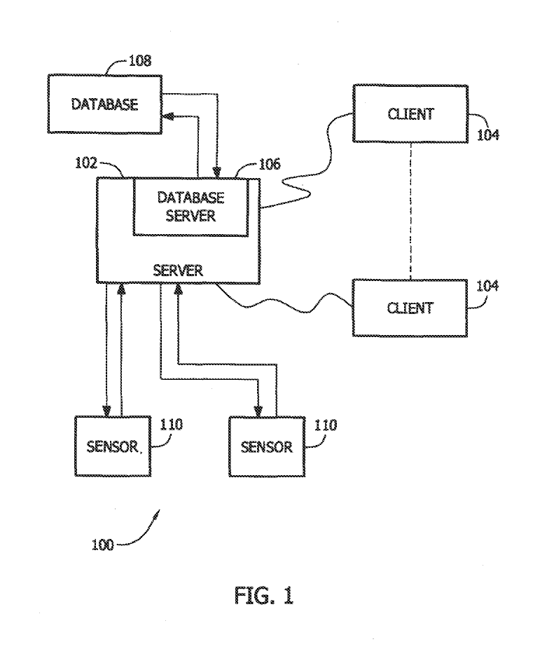

FIG. 1 is a simplified block diagram of an exemplary medical event system 100 for use in gathering and processing data associated with medical events, and for use in using the gathered data in training physicians, surgeons, surgical residents, surgeons in training, and/or other medical or healthcare personnel, for example, on surgical procedures and practices. In the exemplary embodiment, system 100 includes a server system 102, and a plurality of client computers 104 communicatively connected to server system 102. In one embodiment, client computers 104 include a web browser and/or a client software application, such that server system 102 is accessible to client computers 104 over a network, such as the Internet and/or an intranet. Client computers 104 are interconnected to the Internet through many interfaces including a network, such as a local area network (LAN), a wide area network (WAN), dial-in-connections, cable modems, wireless modems, and/or special high-speed Integrated Services Digital Network (ISDN) lines. As described above, client computers 104 may be any device capable of interconnecting to the Internet including a computer, web-based phone, personal digital assistant (PDA), or other web-based connectable equipment. A database server 106 is connected to a memory area 108 containing information on a variety of matters, such as information relating to one or more areas of interest (AOIs). In one embodiment, centralized memory area 108 is stored on server system 102 and is accessed by potential users at one of client computers 104 by logging onto server system 102 through one of client computers 104. In an alternative embodiment, memory area 108 is stored remotely from server system 102 and may be non-centralized.

Memory area 108 may include one, or more than one, forms of memory. For example, memory area 108 can include random access memory (RAM), which can include non-volatile RAM (NVRAM), magnetic RAM (MRAM), ferroelectric RAM (FeRAM) and other forms of memory. Memory area 108 may also include read only memory (ROM), flash memory and/or Electrically Erasable Programmable Read Only Memory (EEPROM). Any other suitable magnetic, optical and/or semiconductor memory, by itself or in combination with other forms of memory, may be included in memory area 108. Memory area 108 may also be, or include, a detachable or removable memory, including, but not limited to, a suitable cartridge, disk, CD ROM, DVD or USB memory.

Furthermore, memory area 108 may be organized as a database to store medical event information. As described in more detail below, and as used herein, the term medical event refers to a triggering incident between a patient and a health care provider, in which a legal allegation or assertion is asserted and filed against the health care provider after the incident, that the medical treatment received by the patient fell below an accepted standard of practice in the medical community, (i.e., that the quality of care they received was substandard) and that such treatment caused harm, injury, or death to the patient. It should be noted that medical events may involve incidents in which no medical errors were committed, and/or incidents in which the associated hospital, doctor, or any other health care professional was not liable for all the harms a patient suffered. The present application is directed towards medical events relating to surgical procedures, and exemplary triggering events in the exemplary embodiment may include, but are not limited to only including, operations performed on the wrong part of the patient's body, misdiagnosis of the patient's condition, leaving objects in the patient's body after surgery, persistent pain after surgery, and/or post-surgical complications, including for example, potentially fatal infections. Although the present application is described herein with respect to medical events relating to surgical procedures, in other medical events, relating to non-surgical events, other triggering events may be stored in memory area 108, such as but not limited to, patients receiving the wrong dosage of medication, the wrong diagnosis, or the wrong medication. Moreover, and as described in more detail below, the present application is not limited to being used only with surgical procedures, medical treatments, or medical events, and one of ordinary skill in the art should realize that the present invention could be utilized in a variety of different non-medical fields.

Moreover, as described in more detail below, in the exemplary embodiment, memory area 108 also stores past medical/surgical decisions made by healthcare professionals, and the underlying reasons for their decisions, if such reasoning is available. In addition, memory area 108 stores a failure analysis for each medical event. Furthermore, in the exemplary embodiment, memory area 108 may include a time stamp for each datum that has been entered or modified within memory area 108. Because memory area 108 may include data associated with multiple triggering events arising from the same medical event, and/or data from a plurality of similar medical events, each datum stored within memory area 108 is marked by an identifier that corresponds to an AOI that relates to the relevant datum.

Server system 102 uses the stored information to assist healthcare professionals in making future decisions based on past medical decisions, human intellectual or factual reasoning, and/or any other decision factors associated with the medical events stored in memory area 108. Moreover, system 102 enables healthcare professionals to be trained on surgical procedures and the technical issues surrounding a surgical procedure, based on the risks and malpractice issues and/or other legal issues associated with such surgical procedures in the past. Furthermore, system 102 enables information associated with medical events to be continually updated. For example, in the exemplary embodiment, memory area 108 and server system 102 can form a learning-based system that is based on past actions and decisions relating to medical events, for use as a future decision-making tool for healthcare professionals performing similar surgical procedures in the future. Moreover, because the database is sortable, decisions made by multiple healthcare providers and the reasoning associated with their decisions can be easily grouped or sorted, such that deviations in the decisions can be easily identified. Accordingly, server system 102 combines the human intellect, the associated past conditions, and the failure events associated with past medical events that that triggered the filing of a legal assertion, accumulated over time, to form a database of data representative of past deviations from expected patient results.

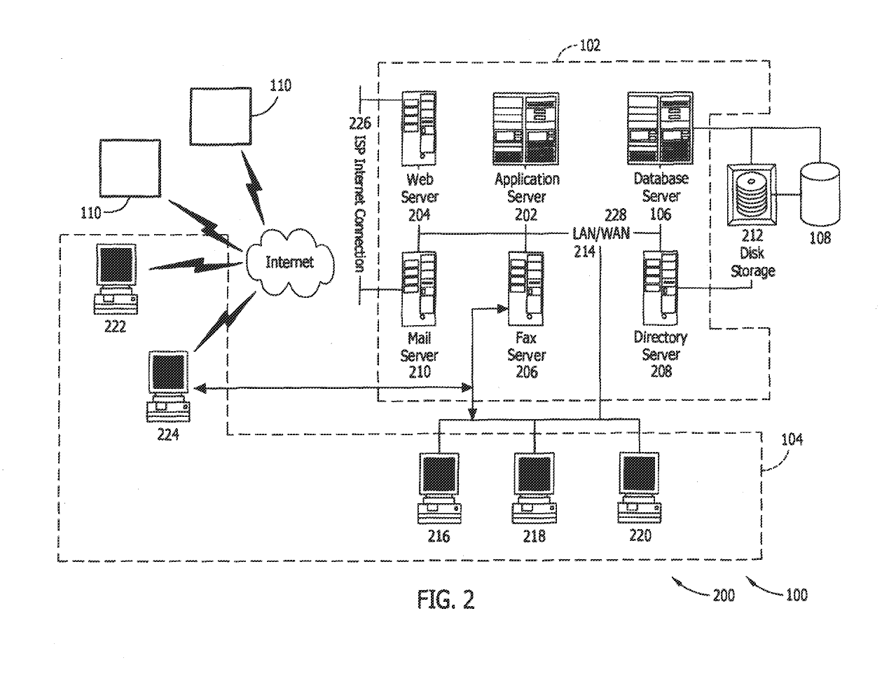

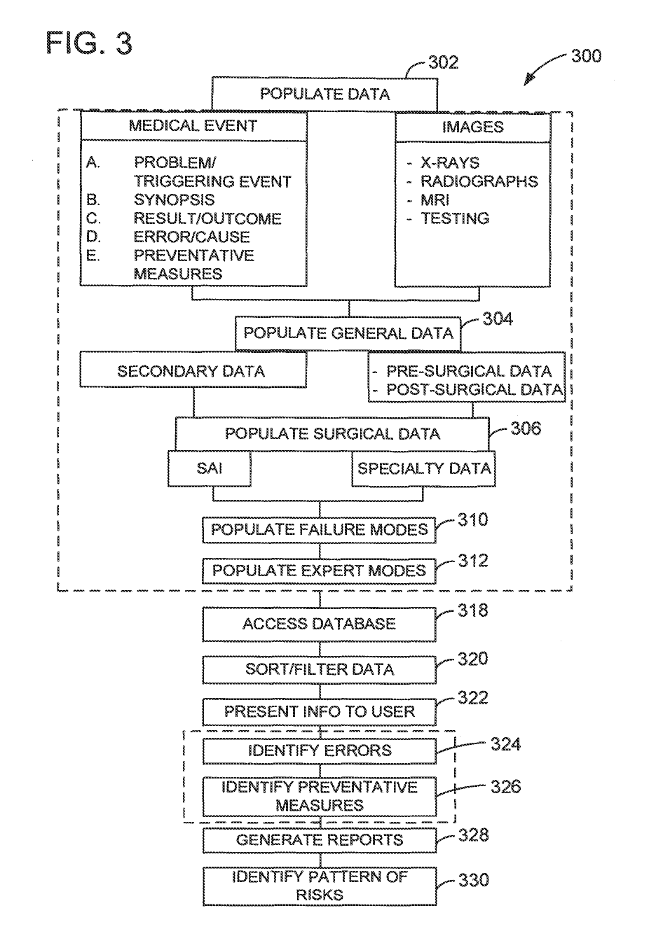

FIG. 2 is an expanded block diagram of an exemplary system architecture 200 of a medical event training system 100 (shown in FIG. 1). Components in system architecture 200, identical to components of system 100, are identified in FIG. 2 using the same reference numerals as used in FIG. 1. In the exemplary embodiment, system 200 includes server system 102 and client computers 104. Server system 102 also includes database server 106, an application server 202, a web server 204, a fax server 206, a directory server 208, and a mail server 210. A disk storage unit 212 is coupled to database server 106 and directory server 208. Examples of disk storage unit 212 include, but are not limited to including, a Network Attached Storage (NAS) device and a Storage Area Network (SAN) device. Database server 106 is also coupled to memory area 108. Servers 106, 202, 204, 206, 208, and 210 are coupled in a local area network (LAN) 214. Client computers 104 may include a system administrator workstation 216, a user workstation 218, and a supervisor workstation 220 coupled to LAN 214. Alternatively, client computers 104 may include workstations 216, 218, 220, 222, and 224 that are coupled to LAN 214 using an Internet link or are connected through an intranet.

Each client computer 104, including workstations 216, 218, 220, 222, and 224, may be a personal computer having a web browser and/or a client application. Server system 102 is configured to be communicatively coupled to client computers 104 to enable server system 102 to be accessed using an Internet connection 226 provided by an Internet Service Provider (ISP). The communication in the exemplary embodiment is illustrated as being performed using the Internet, however, any suitable wide area network (WAN) type communication can be utilized in alternative embodiments, that is, the systems and processes are not limited to being practiced using the Internet. In addition, local area network 214 may be used in place of WAN 228. Further, fax server 206 may communicate with remotely located client computers 104 using a telephone link.

Moreover, in the exemplary embodiment, server system 102 is communicatively coupled to one or more remote sensors 110 that acquire data, such as data associated with a medical event. Server system 102 is configured to be communicatively coupled to each sensor 110 to enable server system 102 to access each sensor 110 using Internet connection 226. The communication in the exemplary embodiment is illustrated as being performed using the Internet, however, any suitable wide area network (WAN) type communication can be utilized in alternative embodiments, that is, the systems and processes are not limited to being practiced using the Internet. In addition, local area network 214 may be used in place of WAN 228. Server system 102 is further configured to extract data from each sensor 110 that is specified as a data origin. Server system 102 extracts the data and stores the data within memory area 108.

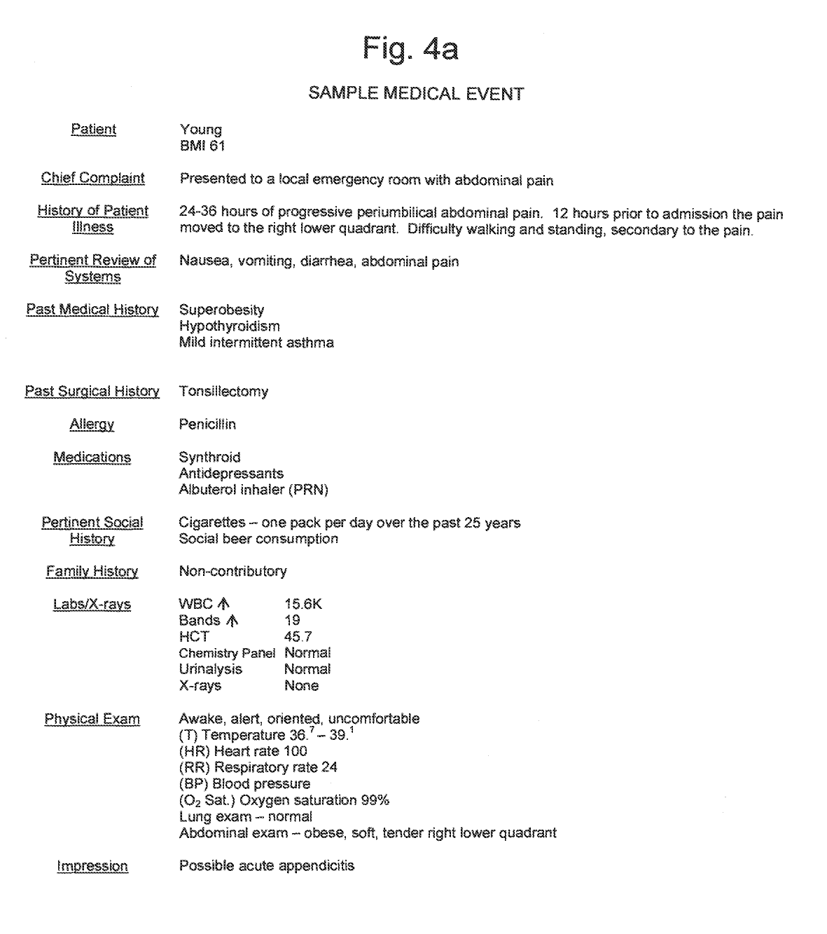

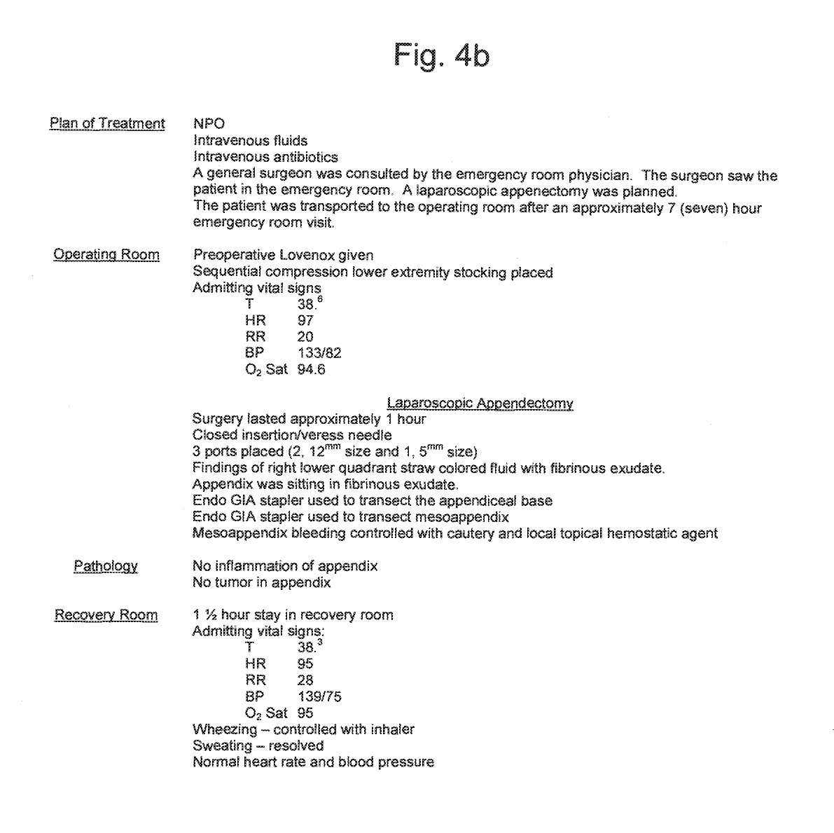

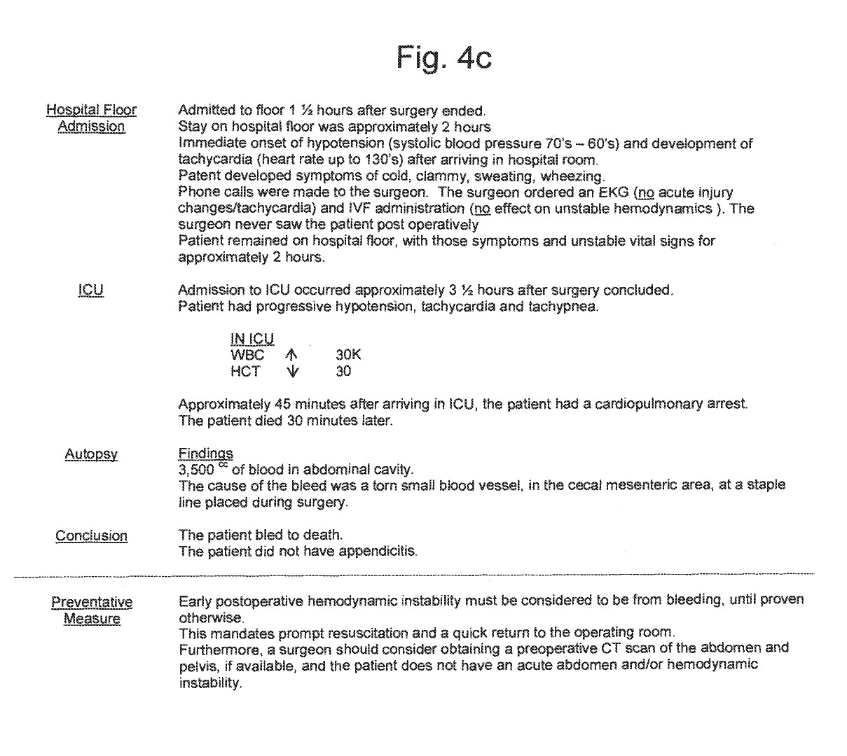

FIG. 3 is a flowchart 300 of an exemplary method for generating and using an intelligent future-decision tool, such as medical event information system 100 (shown in FIG. 1). FIG. 4A-C is an exemplary sample report that may be generated using medical event information system 100. Moreover, in the exemplary embodiment, the method illustrated in flowchart 300 is described in conjunction with medical events that were triggered following surgical procedures. In other embodiments, the method illustrated in flowchart 300 is used in conjunction with medical treatments that are non-surgical. Alternatively, in other embodiments, system 100 can be populated 302 with non-medical event data and used with any industry to train employees and to assist their future decisions, based on errors generated in the past in their industry, in which a legal assertion was filed. For example, in other embodiments, memory area 108 (shown in FIG. 1) stores information associated with legal malpractice events and system 100 is used to train less experienced lawyers and/or law school students on legal handlings, based primarily on past errors in legal judgment and/or a lack of knowledge that lead to legal assertions being filed in the past. In other embodiments, system 100 is used to train individuals in the government, including those involved with Medicare® or other programs used to pay health care expenses, individuals in the insurance field, including those in companies that contract with health care providers, individuals in the academic or education arena, and/or individuals employed by hospitals, surgery centers, and/or medical institutions, for example. Alternatively, system 100 may be used to assist any individual in any field, in making future decisions based on past decisions, human intellectual or factual reasoning, and/or any other decision factors associated with the events relating to their field, that caused a legal assertion to be filed, and in each embodiment, system 100 may be used to train such individuals on current procedures, and the associated technical issues surrounding such procedures, based on the risks and malpractice issues and/or other legal issues associated with such procedures in the past.

Initially, memory area 108 is populated 302 with data associated with previous medical events, and reviews of the associated legal-based events, including an identification of the mistakes made and/or mistakes alleged to have occurred, as well as the outcome of the medical event. More specifically, in the exemplary embodiment, memory area 108 is populated 302 with data, associated with medical events, that identifies for each medical event, but is not limited to only identifying:
a. the problem or problems that initially triggered the medical event, and any additional/subsequent problems that developed either during or after the surgical procedure that contributed to the medical event being triggered;
b. a synopsis of the management associated with the problem, including, the initial diagnosis, and if available, an analysis provided by the healthcare professional performing the surgical procedure;
c. the result, damages, consequences, and/or outcome of the surgical procedure(s) associated with the medical event;
d. the error(s) that caused the result, damages, consequences, and/or outcome of the surgical procedure(s) associated with the medical event; and
e. any steps or practices that would have prevented the result, damages, consequences, and/or outcome of the surgical procedure(s) associated with the medical event.

Alternatively, or in the addition, memory area 108 may also be populated 302 with additional information associated with each medical event. For example, information associated with treatment options initially presented to the patient, the healthcare provider's initial assessment of the patient's condition, data associated with the general standard of care, if available, and/or copies of pertinent literature. In addition, or in the alternative, memory area 108 may also include information relating to the surgical technique employed, any special circumstances associated with the surgical procedure, any patterns of risk associated with the procedure, the particular patient, and/or the particular surgeon, any risk response options, and information associated with intra-operative and post-operative notation tips. Furthermore, memory area 108 may include copies of pertinent outputs of medical testing or of monitoring instrument(s) or device(s), such as, but not limited to X-rays, radiographs, or magnetic resonance images, or information relating to such outputs or testing. Additionally, or in the alternative, memory area 108 may be populated 304 with any other information associated with the medial event that was pertinent to the underlying legal issues that were triggered, such as, but not limited to an analysis of alternative treatment options that were available, and/or an analysis of potential complications that may have been present before the surgical procedure was performed.

In addition, in the exemplary embodiment, for each medical event, memory area 108 is also populated 304 with data associated with the specific patient that underwent the surgical procedure. For example, memory area 108 may include patient details that identify the patient's history of the illness and or trauma that created a need for the surgical procedure, an analysis of the patient's medical and/or surgical histories, and/or a description of any medications or allergies associated with the patient. Additional patient information may include a discussion of the patient's social history, family medical history, and the results of any initial patient examinations performed before and/or after the surgical procedure.

Memory area 108 may also be populated 304 with medical secondary data associated with the patient associated with each medical event or with the medical treatment. For example, such medical secondary data may include, but is not limited to only including: information taken from the patient's medical records, and/or a drug reference section that includes known side effects and contraindications of any drugs taken by the patient. Additional information stored in memory area 108 may include other information associated with the patient or medical treatment, including, but not limited to the discharge summary, physician progress notes, nurses' notes, post-surgical psychiatry consult notes, an operative/surgical report, the anesthesia record, the recovery room record, an incident report detailing the patient injury, an intraoperative nursing care record, and/or standard of care documents. Additionally, memory area 108 may include reports from a morbidity/mortality committee, copies of relevant hospital/department procedures and manuals, and/or an autopsy report.

After a medical event has been entered in memory area 108, system 100 uses a strategic combination of cognitive, technical, and risk-reduction tips to provide an effective tool that may be used to facilitate enhancing surgical skills and to substantially reduce or eliminate patient injury or dissatisfaction, as well as a risk of medical malpractice claims.

In the exemplary embodiment, to facilitate more effective sorting and filtering, memory area 108 is also populated 306 with information used to identify the surgical specialty category or surgical area of interest (SAI) associated with the medical event. For example, in the exemplary embodiment, exemplary surgical specialties categories include, but are not limited to only including, colorectal surgery, dermatologic surgery, general surgery, neurosurgery, ob-gyn, ophthalmologic surgery, orthopedic surgery, otolaryngological surgery, plastic surgery, urologic surgery, pediatric surgery, and cardio-thoracic surgery.

In addition, in the exemplary embodiment, each specialty medical event is also associated with information identifying specific procedures in each surgical category. For example, in one embodiment, the surgical procedures in the orthopedic specialty may include, but are not limited to only including, any of the following: acromioplasty, adhesive capsulitis of shoulder, ankle replacement, anterior cervical discectomy, anterior cruciate ligament reconstruction, anterior interval release, arthrex, arthrodesis, arthroplasty, arthroscopy, arthrotomy, articular cartilage stem cell paste grafting, astragalectomy, autologous matrix-induced chondrogenesis, autotransplantation. Bioceramic, bone cement, bone cutter, bone grafting, Broström procedure, Brunelli procedure, bursectomy. Chiroplasty, chondroplasty, coccygectomy, corpectomy, corticotomy, Cotrel-Dubousset instrumentation, Darrah procedure, disc biacuplasty, Disc decompression traction procedure, distraction osteogenesis, dynamic compression plate, dynamic hip screw, epiphysiodesis, Evans technique, external fixation, femoral head ostectomy, femoral neck targeting, foot and ankle surgery, foraminotomy, four corner fusion, Gaenslen's test, hand surgery, Harrington rod, Hip arthroscopy, hip replacement, hip resurfacing, Hippocratic bench, Hubscher's maneuver, internal fixation, interspinous process decompression, intramedullary rod, joint replacement, khyphoplasty, Kirschner wire, knee cartilage replacement therapy, knee osteoarthritis, knee replacement, Krukenberg procedure, laminectomy, laminoplasty, laminotomy, lateral release, ligamentotaxis, meniscal cartilage replacement, meniscus transplant, microfracture surgery, microsurgical lumbar laminoplasty, osseoincorporation, osseointegration, ostectomy, osteolysis, osteostimulation, osteotomy, percutaneous pinning, percutaneous vertebroplasty, piezosurgery, Ponseti method, prolotherapy, reduction, rotationplasty, Schilling tendon procedure, shoulder surgery, spinal fusion, sulcoplasty, supracondylar humerus fracture, synovectomy, tendon transfer, Tessys method, tibial-plateau-leveling osteotomy, tissue expansion, Tommy John surgery, triple arthrodesis, triple tibial osteotomy, vertebral fixation, and vesselplasty.

In addition, memory area 108 stores failure modes associated with each medical event. More specifically, in the exemplary embodiment, each medical event stored in memory area 108 is also identified and populated 310 with a failure mode that further enables the database to be sorted. For example, in one embodiment, exemplary failure modes associated with an appendectomy medical event include, but are not limited to only including:

1. wrong preoperative diagnosis;

2. wrong intraoperative diagnosis;

3. wrong choice of laparoscopic entry into abdomen;

4. vascular injuries as a result of the surgical procedure;

5. bowel injuries as a result of the surgical procedure; and

6. missed diagnosis of postoperative infection.

In the exemplary embodiment, because each medical event resulted in a legal assertion being filed, memory area is also populated 312 with expert consultation notes/remarks that may also be associated with each medical event stored in memory area 108. Such notes/remarks are generally completed by healthcare professionals reviewing the medical events stored in memory area 108 and may include, but are not limited to including, notes relating to each medical event reviewed by that individual or a group of experts.

In the exemplary embodiment, to initiate training, a user accesses 318 the database stored in memory area 108. In one embodiment, the database is filtered/sorted 320 such that a desired surgical category or surgical procedure is selected from or input into system 100 using a client computer 104 (shown in FIG. 1), for example. In another embodiment, a user may select a desired surgical procedure from a pull-down menu displayed to the user, i.e., from a selection tree, for example. System 100 is searchable based on any data stored in memory area 108. More specifically, the user may selectively filter and/or organize 320 the data to be retrieved by using pre-defined category identifiers or terms stored in server system 102, or the user may selectively filter and/or organize 320 the data by inputting desired search terms. The user may also selectively filter and/or organize 320 the data using any relevant fields stored for each medical event.

In the exemplary embodiment, after a desired surgical procedure is selected, and the data in memory area 108 is filtered and sorted 320, using stored inputs from healthcare professionals regarding each medical event, stored established healthcare standards, and any other data stored in memory area 108, server system 100 presents 322 the information to the user and identifies errors 324 committed in each medical event. Based on the identified errors, corrective measures or practices can be identified 326 that can be implemented or that should be followed to prevent such medical events in the future, and to prevent similar mistakes and errors from occurring.

After accessing data relevant to a specific surgical procedure, health care professionals may be trained regarding the surgical procedure, using the data input into memory area 108 as the foundation of their training. As such, the individuals receiving training learn based on a comprehensive review of errors and mistakes committed in the past, and learn that if preventive measures are implemented, the events that created the medical event can be prevented. System 100 facilitates improving the technical skills of the healthcare provider and thus facilitates improving the quality of patient care, while reducing the risks of errors, patient harm, patient dissatisfaction, and the likelihood of malpractice claims. Moreover, as a result, over time the likelihood of errors being repeated, that gave rise to legal assertions being filed is reduced, while the future decision process of the healthcare provider is improved. In some embodiments, system 100 will assemble data 328 relating to a specific medical event stored in memory area 108 into a summary report, as is illustrated in FIG. 4A-C. Such a report may be populated with data from a plurality of different sources input into memory area 108. Moreover, in one embodiment, system 100 will generate a report that, based on, for example, the failure modes, the deviations identified, the errors identified, the corrective actions identified and/or other data associated with the medical events stored in memory area 108, identifies patterns of risks that may lead to medical malpractice claims associated with the surgical procedure. Furthermore, in the exemplary embodiment, system 100 will identify 330 patterns of risks for medical malpractice claims based on the filtered medical events accessed from memory area 108.

Exemplary embodiments of systems, methods, and apparatus for use in generating and using an intelligent future-decision tool for use in various stages of surgical procedure training are described above in detail. The systems, methods, and apparatus are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

A computer or server, such as those described herein, includes at least one processor or processing unit and a system memory. The computer or server typically has at least some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

Although the present invention is described in connection with surgical procedure training, embodiments of the invention are operational with numerous other general purpose or special purpose medical event information system environments or configurations. The medical event information system environment is not intended to suggest any limitation as to the scope of use or functionality of any aspect of the invention. Moreover, the medical event information system environment should not be interpreted as having any dependency or requirement relating to any one or combination of components illustrated in the exemplary operating environment. Examples of medical event information systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program components or modules, executed by one or more computers or other devices. Aspects of the invention may be implemented with any number and organization of components or modules. For example, aspects of the invention are not limited to the specific computer-executable instructions or the specific components illustrated in the figures and described herein. Alternative embodiments of the invention may include different computer-executable instructions or components having more or less functionality than illustrated and described herein.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, the term “processor” refers generally to any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, the term “database” refers generally to any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

When introducing elements of aspects of the invention or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of training a healthcare provider to perform a surgical procedure, said method comprising:
accessing, from a plurality stored medical events that each resulted in a legal assertion being made by a patient following a surgical procedure, data including at least information relating to each patient associated with each medical event, information associated with errors relating to the medical event, and information relating to the outcome of at least one of the surgical procedure associated with each medical event;
identifying, from the plurality of stored medical events, information relating to the surgical procedure to be performed;
identifying, if corrected, at least one action that would have changed the outcome of each of the medical events identified; and
presenting the identified information to the healthcare provider to facilitate reducing the likelihood of errors being committed by the healthcare provider to perform the surgical procedure and to facilitate improving a quality of care provided by the healthcare provider.

2. A method in accordance with claim 1, wherein presenting the identified information to the healthcare provider further comprises presenting the identified information to the healthcare provider to facilitate reducing medical malpractice claims relating to the surgical procedure.

3. A method in accordance with claim 1, wherein accessing, from a plurality of stored medical events that each resulted in a legal assertion being made by a patient following a surgical procedure, further comprises identifying deviations in the plurality of medical events associated with the surgical procedure.

4. A method in accordance with claim 1, wherein accessing, from a plurality of stored medical events that each resulted in a legal assertion being made by a patient following a surgical procedure, further comprises identifying a failure mode associated with each of the plurality of medical events accessed.

5. A method in accordance with claim 4, further comprising:
identifying deviations in the plurality of medical events associated with the surgical procedure; and
generating, based on the identified failure modes and deviations, a report identifying patterns of risks associated with the surgical procedure.

6. A method in accordance with claim 1 wherein accessing, from a plurality of stored medical events that each resulted in a legal assertion being made by a patient following a surgical procedure, further comprises accessing data relating to at least one of each triggering event associated with each of the plurality of medical events accessed, a synopsis of the healthcare management associated with each of the plurality of medical events accessed, and a listing of treatment options presented to each patient prior to each surgical procedure associated with each of the plurality of medical events accessed.

7. A medical event information system comprising:
at least one client computer;
a memory area configured to store data associated with a plurality of medical events, wherein each medical event resulted in a legal assertion being made by a patient following a surgical procedure; and
a server system communicatively coupled to said at least one client computer and to said memory area, said server system configured to:
receive from said at least one client computer data associated with each of the plurality of medical events, wherein the data includes at least information relating to each patient associated with each medical event, information associated with errors relating to the medical event, and information relating to the outcome of at least one of the surgical procedure associated with each medical event;
identify at least one action associated with each medical event that if corrected would have changed the outcome of each of the medical events identified; and
transmit to said at least one client computer for display to a user, a comparison between at least one error and at least one identified corrective action associated with each medical event to facilitate reducing errors performed by a healthcare provider performing a similar surgical procedure in the future.

8. A system in accordance with claim 7 wherein said server system is further configured to identify deviations in the plurality of stored medical events associated with the surgical procedure.

9. A system in accordance with claim 8 wherein said server system is further configured to present the identified information to the user to facilitate reducing medical malpractice claims relating to the surgical procedure.

10. A system in accordance with claim 8 wherein said server system is further configured to identify at least one failure mode associated with each of the plurality of medical events stored in said memory area.

11. A system in accordance with claim 8 wherein said server system is further configured to receive from said at least one client computer, data associated with at least one triggering event associated with each of the plurality of medical events.

12. A system in accordance with claim 8 wherein said server system is further configured to receive from said at least one client computer, data relating to a synopsis of the healthcare management associated with each of the plurality of medical events accessed, and a listing of at least one treatment option presented to each patient prior to each surgical procedure, associated with each of the plurality of medical events.

13. A system in accordance with claim 8 wherein said server system is further configured to present to the user, data identifying patterns of risks associated with the surgical procedure.

14. A method of training a healthcare provider to perform a medical treatment, said method comprising:
accessing, from a plurality stored medical events, data including at least information relating to each patient associated with each medical event, information associated with errors relating to the medical event, and information relating to the outcome of at least one of the medical treatment associated with each medical event;
identifying, from the plurality of stored medical events, information relating to the medical treatment to be performed by the healthcare provider;
identifying, if corrected, at least one action that would have changed the outcome of each of the medical events identified; and
presenting the identified information to the healthcare provider to facilitate reducing the likelihood of errors being committed by the healthcare provider when performing the medical treatment and to facilitate improving a quality of care provided by the healthcare provider.

15. A method in accordance with claim 14 further comprising:
identifying deviations in the plurality of stored medical events accessed and associated with the medical treatment; and
presenting the deviations to the healthcare provider.

16. A method in accordance with claim 15 further comprising:
identifying patterns of risks associated with the medical treatments, based on the plurality of medical events accessed; and
presenting the patterns of risks to the healthcare provider.

17. A method in accordance with claim 15 further comprising:
identifying a failure mode associated with each of the plurality of medical events accessed; and
presenting the failure modes to the healthcare provider.

18. A method in accordance with claim 15 wherein accessing, from a plurality of stored medical events that each resulted in a legal assertion being made by a patient following a medical treatment further comprises:
accessing data relating to at least one triggering event associated with each of the plurality of medical events accessed; and
presenting the triggering events to the healthcare provider.
